(19) United States
(12) Patent Application Publication
(10) Pub. No.: US 2009/0095417 A1
(43) Pub. Date: Apr. 16, 2009

(54) Heat treatment method for an expanded polytetrafluoroethylene membrane

(75) Inventor: Gopakumar Thottupurathu, Kansas (CA)

Correspondence Address: NIXON & VANDERHYE P.C., 901 NORTH GLEBE ROAD, 11TH FLOOR, ARLINGTON, VA, 22203, US

(73) Assignee: General Electric Company, Schenectady, NY (US)

(21) Appl. No.: 11/907,331

(22) Filed: Oct. 11, 2007

(51) Int. Cl. B32B 37/16

(52) U.S. Cl. 156/299

(57) ABSTRACT

A method of heat treating an expanded polytetrafluoroethylene (ePTFE) membrane to improve the hydrostatic strength of the membrane includes: a. heating the ePTFE membrane to a temperature of about 400° C. for about 2 minutes; and b. cooling the ePTFE membrane at a temperature of 0-5° C. or at about 22-25° C. for about 5 minutes.

### BACKGROUND OF THE INVENTION

It is known that technical fabrics must be suitable for use in demanding applications. Examples of such demanding applications include filter elements, outerwear garments and apparel, footwear, tents, sleeping bags, protective garments, clean room garments, surgical drapes and gowns, other types of barrier wear and allergen barrier products. Such technical fabrics often include a film or membrane to protect the fabric user from an external condition or environment and/or protect the external environment from contamination by the user.

A known material for a membrane that has proven particularly suitable for such demanding applications is expanded polytetrafluoroethylene (“ePTFE”) material. It is known that ePTFE membranes are microporous and therefore air permeable and moisture vapor transmissive, yet resistant to wind and liquid penetration at moderate pressures. ePTFE membranes are typically laminated to at least one other material, such as a textile base or shell fabric. The resulting membrane and fabric laminate can be used in the manufacture of any number of finished products, such as those identified above, to meet the demands of the particular application.

More specifically, when the compound PTFE (e.g., Teflon®) is expanded, millions of microscopic pores are created in a three-dimensional membrane structure. These pores are smaller than almost any type of airborne or waterborne particulate, yet large enough to allow for the passage of gas molecules. Unlike nonporous membrane materials such as polyurethane, ePTFE provides a controlled level or air permeability. In outdoor apparel applications, this allows moisture vapor generated by the user to escape through the membrane, providing comfort while protecting the user from rain, wind and cold. At the same time, the membrane has excellent hydrophobicity so it is considered to be waterproof at a relatively low challenge pressure.

ePTFE membranes, however, have poor hydrostatic strength (below 18 psi) and therefore, in many apparel applications and, as noted above, the membrane is often laminated to shell or textile fabric to improve hydrostatic strength of the combined fabric.

### BRIEF DESCRIPTION OF THE INVENTION

This invention discloses a new method for improving hydrostatic strength of ePTFE membranes. In the non-limiting embodiment disclosed herein, the membrane is subjected to a post heat treatment and subsequently cooled by a controlled cooling process. The Mullen strength of the heat treated membrane is improved up to 30 psi and the membrane also passed the test for sustained Mullen strength (ASTM D3393), thus evidencing improved water proofness of the ePTFE membrane.

Thus, in one aspect, there is provided a method of heat treating an expanded polytetrafluoroethylene (ePTFE) membrane comprising: (a) heating the ePTFE membrane to a temperature of about 400° C. for a time of about 2 minutes; and (b) cooling the ePTFE membrane at a temperature of 0-5° C. for a time of about 5 minutes.

In another aspect, there is provided a method of heat treating an expanded polytetrafluoroethylene (ePTFE) membrane comprising: (a) heating the ePTFE membrane to a temperature of about 400° C. for a time of about 2 minutes; and (b) cooling the ePTFE membrane at a temperature of about 22-25° C. for a time of about 5 minutes.

### DETAILED DESCRIPTION OF THE INVENTION

In one non-limiting, exemplary embodiment, an ePTFE membrane, prior to any lamination with a fabric, was heat-treated to about 400° C. (e.g., 400° C.±5° C.) for a period of about 2 minutes (e.g., 2 minutes±30 seconds). The membrane was then cooled in an ice-cold (0-5° C.) water bath for about 5 minutes (e.g., 5 minutes±30 seconds). The membrane treated in the above manner exhibited a Mullen strength of up to 30 psi and passed the sustained Mullen strength test (ASTM D3393).

Other property changes included:

### DSC—Crystallinity (%)

Before heat treatment—44
After heat treatment—16
Tensile Strength (psi)
Before heat treatment—

Machine Direction 1.09

Transverse Direction 2.78

After heat treatment

Machine Direction 1.21

Transverse Direction 2.25

Tensile Modulus (psi)
Before heat treatment

Machine Direction 984

Transverse Direction 1178

After heat treatment

Machine Direction 1204

Transverse Direction 14511

Peel Strength (lb f/Inches)
Before heat treatment

Machine Direction 0.40

Transverse Direction 0.23

After heat treatment

Machine Direction 0.97

Transverse Direction 0.74

Elongation (% from Original)
Before heat treatment

Machine Direction 383

Transverse Direction 71

After heat treatment

Machine Direction 332

Transverse Direction 56

### Dimensional Stability—% Shrinkage

Before heat treatment

Machine Direction 27

Transverse Direction 19

After heat treatment

Machine Direction 0

Transverse Direction 0

In a second, non-limiting exemplary embodiment, the membrane was heated similarly but cooled for about five minutes (e.g., 5 minutes±30 seconds) at room temperature (i.e., 22-25° C.±5° C.). The membrane also passed the sustained Mullen strength test, with a Mullen strength of up to 30 psi.

Other property changes included:

### DSC—Crystallinity (%)

Before heat treatment 44

After heat treatment 20

Tensile Strength (psi)
After post treatment

Machine Direction 1.28

Transverse Direction 2.44

Tensile Modulus (psi)
After post treatment

Machine Direction 1256

Transverse Direction 17376

Peel Strength (lb f/Inches)
After heat treatment

Machine Direction 0.94

Transverse Direction 0.78

Elongation (% from Original)
After heat treatment

Machine Direction 3344

Transverse Direction 50

Dimensional Stability—% Shrinkage

After post heat treatment

Machine Direction 2

Transverse Direction 3

In the above examples, reference to “Machine Direction” is understood as along an axis of the machine in the direction of pulling or sketching the membrane.

The improved properties evident from the test results, especially with respect to strength and dimensional stability, provide improved hydrostatic strength which, in turn, improves the water-proofness of the membrane, even in harsh environments.

The improved water-proofness also gives greater flexibility in the choice of fabrics subsequently laminated to the membrane, in that water proofness of that fabric may not be the controlling factor given the improved water proofness properties achieved by the methods described herein.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A method of heat treating an expanded polytetrafluoroethylene (ePTFE) membrane comprising:
(a) heating the ePTFE membrane to a temperature of about 400° C. for a time of about 2 minutes; and
(b) cooling the ePTFE membrane at a temperature of 0-5° C. for a time of about 5 minutes.

2. The method of claim 1 further comprising, after step b:
(c) laminating the ePTFE membrane to a fabric.

3. The method of claim 1 wherein, in step (a) the temperature is 400°±5° C.

4. The method of claim 1 wherein, in step (a), the time is 2 minutes±30 seconds.

5. The method of claim 1 wherein, in step (b), the time is 5 minutes±30 seconds.

6. A method of heat treating an expanded polytetrafluoroethylene (ePTFE) membrane comprising:
(a) heating the ePTFE membrane to a temperature of about 400° C. for a time of about 2 minutes; and
(b) cooling the ePTFE membrane at a temperature of about 22-25° C. for a time of about 5 minutes.

7. The method of claim 6 further comprising, after step (b)
(c) laminating the ePTFE membrane to a fabric.

8. The method of claim 6 wherein, in step (a) the temperature is 400°±5° C.

9. The method of claim 6 wherein, in step (a), the time is 2 minutes±30 seconds.

10. The method of claim 6 wherein, in step (b), wherein the time is 5 minutes±30 seconds.
